(19) United States
(12) Patent Application Publication
(10) Pub. No.: US 2011/0235585 A1
(43) Pub. Date: Sep. 29, 2011

(54) APPARATUS AND METHOD FOR TRANSMITTING MESSAGE IN WIRELESS COMMUNICATION SYSTEM

(75) Inventors: Ho-Jung LEE, Suwon-si (KR); Chang-Won SONG, Seoul (KR)

(73) Assignee: SAMSUNG ELECTRONICS CO. LTD., Suwon-si (KR)

(21) Appl. No.: 13/074,311

(22) Filed: Mar. 29, 2011

(30) Foreign Application Priority Data
Mar. 29, 2010 (KR) 10-2010-0027725

(51) Int. Cl. H04W 40/00

(52) U.S. Cl. 370/328

(57) ABSTRACT

An apparatus and a method for transmitting a message in a portable terminal are provided. The method includes determining message contents to send to at least one recipient terminal, determining a number of recipient terminals, when transmitting the message to at least two recipient terminals, determining identification information of at least two recipient terminals to which the message is transmitted, and transmitting a message which includes the identification information of the at least two recipient terminals and the message contents to the at least two recipient terminals.

### PRIORITY

This application claims the benefit under 35 U.S.C. §119(a) of a Korean patent application filed in the Korean Intellectual Property Office on Mar. 29, 2010, and assigned Serial No. 10-2010-0027725, the entire disclosure of which is hereby incorporated by reference.

### BACKGROUND OF THE INVENTION

1. Field of the Invention

The present invention relates to an apparatus and a method for transmitting a message in a wireless communication system. More particularly, the present invention relates to an apparatus and a method for transmitting a response of a message to a plurality of recipients in a portable terminal of the wireless communication system.

2. Description of the Related Art

Portable terminals support voice communication and data communication of mobile users.

Further, portable terminals provide various additional services using diverse application programs.

For example, portable terminals provide a message service. Herein, the message service includes a Short Message Service (SMS), a Multimedia Message Service (MMS), and an E-mail service.

In the message service, one sending terminal can transmit the same message to a plurality of recipient terminals at the same time. In this case, the user of the sending terminal inputs phone numbers of the message recipient terminals one by one, or selects them one by one from a phone book function.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for transmitting a message to a plurality of recipient terminals in a wireless communication system.

Another aspect of the present invention is to provide an apparatus and a method for transmitting a message to a plurality of recipient terminals in a portable terminal of a wireless communication system.

A further aspect of the present invention is to provide an apparatus and a method for transmitting a message to a plurality of recipient terminals in a base station of a wireless communication system.

Yet another aspect of the present invention is to provide an apparatus and a method for transmitting a message response to a plurality of recipient terminals in a portable terminal of a wireless communication system.

In accordance with an aspect of the present invention, a method for transmitting a message in a portable terminal is provided. The method includes determining message contents to send to at least one recipient terminal, determining a number of recipient terminals, when transmitting the message to at least two recipient terminals, determining identification information of at least two recipient terminals to which the message is transmitted, and transmitting a message which includes the identification information of the at least two recipient terminals and the message contents to the at least two recipient terminals.

In accordance with another aspect of the present invention, a method for transmitting a message in a message server is provided. The method includes, when receiving a message from a sending terminal, determining a number of recipient terminals to which the message is transmitted, if it is determined that the message is transmitted to at least two recipient terminals, determining identification information of each recipient terminal to which the message is transmitted, and transmitting the message to the recipient terminals respectively.

In accordance with yet another aspect of the present invention, a method for transmitting a message in a portable terminal is provided. The method includes when receiving a message from a message server, determining whether to send a response to the message, when sending the response to the message, determining identification information in the message of at least one recipient terminal receiving the message from a sending terminal of the message at a same time, and sending the response to the message, the response including identification information of the sending terminal, the identification information of the at least one recipient terminal, and response contents.

In accordance with still another aspect of the present invention, an apparatus for transmitting a message in a portable terminal is provided. The apparatus includes a controller for, when a message is transmitted to at least two recipient terminals, generating a message including identification information of the at least two recipient terminals to which the message is transmitted, and message contents, and a communication module for transmitting the message.

In accordance with a further aspect of the present invention, an apparatus for transmitting a message in a message server is provided. The apparatus includes a communication module for transmitting and receiving messages, and a controller for, when receiving a message from a sending terminal through the communication module, determining a number of recipient terminals to which the message is transmitted, and if it is determined that the message is transmitted to at least two recipient terminals, for controlling to transmit the message to the recipient terminals respectively using identification information of each recipient terminal to which the message is transmitted.

In accordance with still another aspect of the present invention, an apparatus for transmitting a message in a portable terminal is provided. The apparatus includes a communication module for transmitting and receiving messages, and a controller for, when sending a response to a message received through the communication module, determining identification information in the message of at least one recipient terminal receiving the message from a sending terminal of the message at the same time, and generating a response to the message, including identification information of the sending terminal, the identification information of the at least one recipient terminal, and response contents.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a method of a portable terminal for sending a message in a wireless communication system according to an exemplary embodiment of the present invention;

FIG. 2 illustrates a method of a message server for sending a message in a wireless communication system according to an exemplary embodiment of the present invention;

FIG. 3 illustrates a method of a portable terminal for sending a response of a received message in a wireless communication system according to an exemplary embodiment of the present invention;

FIG. 4 illustrates a message including user data information according to an exemplary embodiment of the present invention;

FIG. 5 illustrates a portable terminal in a wireless communication system according to an exemplary embodiment of the present invention; and

FIG. 6 illustrates a message server in a wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

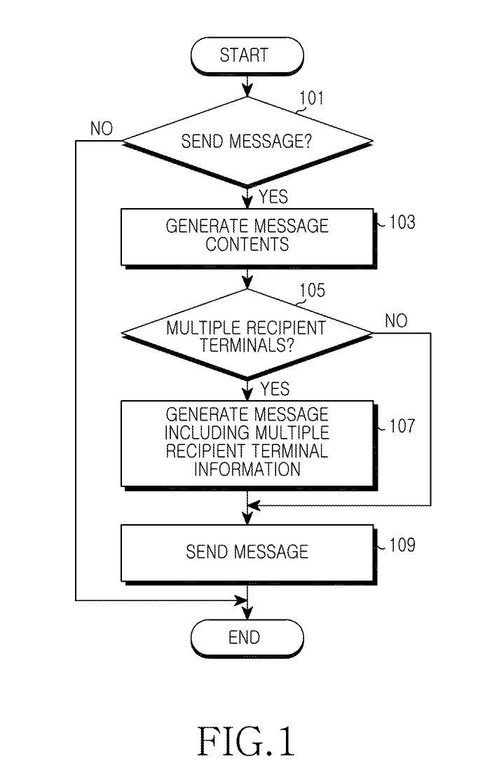

FIGS. 1 through 6, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

An exemplary embodiment of the present invention provides a technique for transmitting a message to a plurality of terminals in a wireless communication system.

Hereinafter, the message includes at least one of a Short Message Service (SMS) message, a multimedia message, and an E-mail.

FIG. 1 illustrates a method of a portable terminal for sending a message in a wireless communication system according to an exemplary embodiment of the present invention.

Referring now to FIG. 1, in step 101, the portable terminal determines whether to send a message to a recipient terminal. For example, the portable terminal may determine whether a message send menu is selected by a user's manipulation.

If it is determined that the portable terminal is not sending the message, the portable terminal finishes this process.

To send a message, the portable terminal generates contents of the message to send to the recipient terminal in step 103. For example, the portable terminal may display a message input window in a display part. Next, the portable terminal determines message contents input by the user through an input part.

In step 105, the portable terminal determines a number of recipient terminals of the message. That is, the portable terminal determines whether the message is to be transmitted to a plurality of recipient terminals. For example, the portable terminal may determine a number of recipient terminals that have been input by the user.

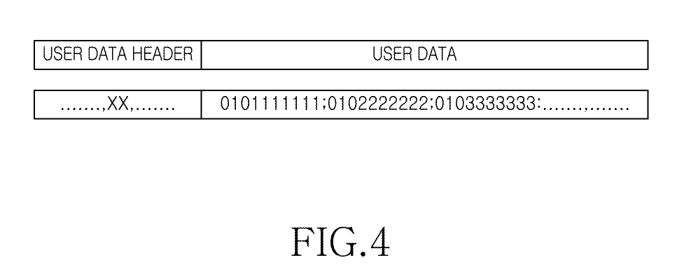

If it is determined that the message is to be transmitted to multiple recipient terminals, the portable terminal generates the message, including information of the message recipient terminals and of the message contents written in step 103, in step 107. For example, the portable terminal may generate the message to include a user data header and user data as shown in FIG. 4.

FIG. 4 illustrates a message including user data information according to an exemplary embodiment of the present invention.

Referring to FIG. 4, the user data includes identification information of the message recipient terminals and the message contents, and the user data header indicates that the user data information includes information of the multiple recipient terminals. Herein, the identification information of the recipient terminal includes a phone number of the recipient terminal, but the present invention is not limited thereto.

Returning to FIG. 1, in step 109, the portable terminal transmits the generated message to a message server.

Meanwhile, if it is determined that a single terminal is to receive the message, the portable terminal transmits the message including the written message contents to the message server in step 109.

Next, the portable terminal finishes this process.

In this exemplary embodiment, the portable terminal sends the message destined for the recipient terminal to a message server.

Alternatively, the portable terminal may send the message destined for the recipient terminal to a base station. In this case, the base station may include the message server.

Now, a method of the message server for transmitting the message from the portable terminal to the recipient terminal is explained.

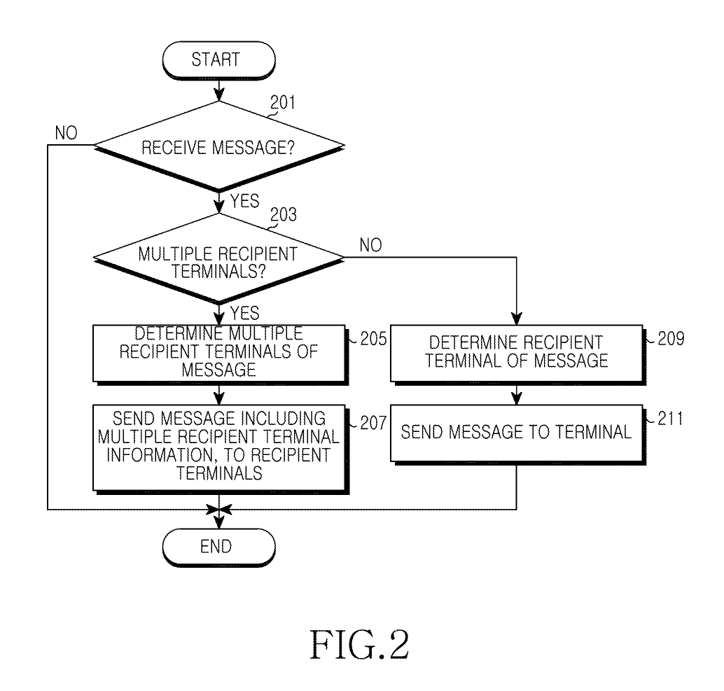

FIG. 2 illustrates a method of a message server for sending a message in a wireless communication system according to an exemplary embodiment of the present invention.

Referring now to FIG. 2, in step 201, the message server determines whether a message is received from the sending terminal.

If it is determined that the message server does not receive the message from the sending terminal, the message server finishes this process.

Upon receiving the message from the sending terminal, the message server determines a number of recipient terminals to receive the message from the sending terminal in step 203. That is, the message server examines whether the sending terminal transmits the message to the plurality of the recipient terminals. For example, the message server may determine whether the sending terminal transmits the message to the plurality of the recipient terminals, based on the user data header of the message received from the sending terminal.

When the sending terminal transmits the message to the plurality of the recipient terminals, the message server determines the identification information of the recipient terminals to receive the message from the sending terminal in step 205. For example, the message server may determine identification information of the recipient terminals to receive the message from the sending terminal, based on the user data of the message received from the sending terminal.

In step 207, the message server forwards the message from the sending terminal to the recipient terminals determined in step 205 respectively. Herein, the message includes the information of the recipient terminals to receive the message from the sending terminal. For example, the message server may transmit the message including the user data header and the user data, as described above with reference to FIG. 4, to the recipient terminals. The user data includes the identification information of the message recipient terminals and the message contents, and the user data header indicates that the user data information includes information of the multiple recipient terminals. Herein, the identification information of the recipient terminals includes the phone numbers of the recipient terminals, but the present invention is not limited thereto.

In contrast, when a single recipient terminal is to receive the message from the sending terminal in step 203, the message server determines the recipient terminal to receive the message from the sending terminal in step 209.

In step 211, the message server forwards the message from the sending terminal to the corresponding recipient terminal.

Next, the message server finishes this process.

The following explanations provide a method of a portable terminal for sending a response to a received message.

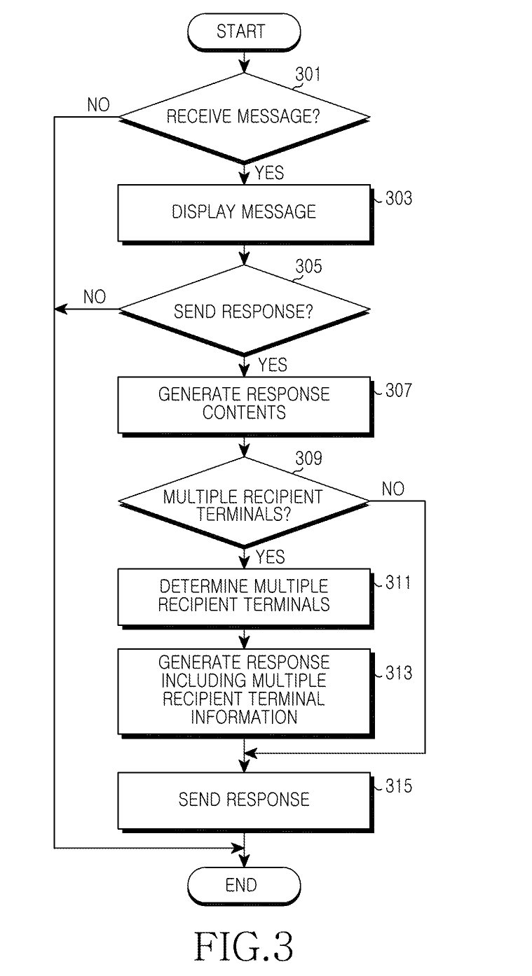

FIG. 3 illustrates a method of a portable terminal for sending a response to a received message in a wireless communication system according to an exemplary embodiment of the present invention.

Referring now to FIG. 3, in step 301, the portable terminal determines whether a message is received. For example, the portable terminal may determine whether a message is received from the message server.

If it is determined that no message is received, the portable terminal finishes this process.

Upon receiving the message, the portable terminal displays the received message in a display part so that the user can determine the message in step 303.

In step 305, the portable terminal determines whether to send a response to the received message. For example, the portable terminal may determine whether a response send menu is selected by the user's key manipulation.

If it is determined not to send a response to the received message, the portable terminal finishes this process.

In contrast, to send the response to the received message, the portable terminal generates contents of the response in step 307. For example, the portable terminal may display a message input window in the display part. Next, the portable terminal determines the message contents input by the user in the message input window through the input part.

In step 309, the portable terminal determines whether to send the response to a plurality of recipient terminals. For instance, the portable terminal may determine whether a multiple recipient terminal send mode is selected by the user.

To send the response to the plurality of the recipient terminals, the portable terminal determines information of the recipient terminals receiving the same message from the sending terminal, in the user data of the received message in step 311. Herein, the sending terminal represents the terminal which originates the received message.

In step 313, the portable terminal generates a message including the information of the determined recipient terminals, the sending terminal, and the response contents. For example, the portable terminal may generate the response including the user data header and the user data as described above with reference to FIG. 4. The user data includes the identification information of the sending terminal, the identification information of the recipient terminals receiving the message from the sending terminal, and the response contents. The user data header indicates that the user data information includes information of the multiple recipient terminals.

In step 315, the portable terminal transmits the generated response to the message server.

In contrast, to send the response to a single recipient terminal, the portable terminal recognizes that the response is transmitted to the sending terminal of the message. Accordingly, the portable terminal sends the response including the response contents to the message server in step 315. The response includes merely the identification information of the sending terminal.

A structure of the portable terminal for transmitting the message is now described. Herein, the portable terminal encompasses every information communication device including mobile communication terminals, Personal Digital Assistants (PDAs), smart phones, International Mobile Telecommunication (IMT)-2000 terminals, Wideband Code Division Multiple Access (WCDMA) terminals, and Universal Mobile Telecommunication Service (UMTS) terminals, etc.

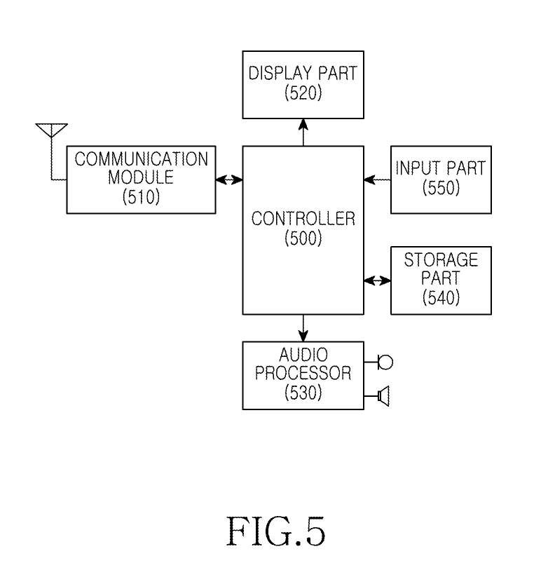

FIG. 5 is a block diagram of a portable terminal in a wireless communication system according to an exemplary embodiment of the present invention.

Referring now to FIG. 5, the portable terminal includes a controller 500, a communication module 510, a display part 520, an audio processor 530, a storage part 540, and an input part 550.

The controller 500 controls operations of the portable terminal. For example, the controller 500 may control voice and data communications.

The controller 500 controls the message transmission of the portable terminal. For instance, when a same message is transmitted to a plurality of recipient terminals at the same time, the controller 500 may generate the response including the user data header and the user data as described above with reference to FIG. 4. Herein, the user data includes the identification information of the recipient terminals and the response contents. The user data header indicates that the user data information includes information of the multiple recipient terminals.

For example, when the message is received through the communication module 510, the controller 500 determines whether to send a response to the message to the plurality of terminals. To send the response to the multiple terminals, the controller 500 can determine information of the recipient terminals receiving the message from the sending terminal, in the user data of the message. Next, the controller 500 generates the response including the information of the terminals to receive the response. In so doing, the controller 500 generates the response including the user data header and the user data as described above with reference to FIG. 4. The user data includes the sending terminal identification information, the identification information of the recipient terminals receiving the message from the sending terminal, and the response contents. The user data header indicates that the user data information includes information of the multiple recipient terminals. Herein, the sending terminal indicates the terminal which originates the message received through the communication module 510.

The communication module 510 processes Radio Frequency (RF) signals transmitted and received over an antenna. For example, the communication module 510 may receive the message from the message server. The communication module 510 transmits the message generated by the controller 500 to the message server.

The display part 520 displays state information, input characters, moving pictures, and still pictures provided from the controller 500. For example, the display part 520 may display the message received from the sending terminal under control of the controller 500. Alternatively, the display part 520 may display the message input by the user through the input part 550.

The audio processor 530 processes to output an audio signal fed from the controller 500 through a speaker. The audio processor 530 provides an audio signal received via a microphone to the controller 500.

The storage part 540 can include a program storage area for storing a program to control operations of the portable terminal, and a data storage area for storing data generated in program execution.

The input part 550 provides input data generated by the user's selection to the controller 500.

Now, a structure of a message server for forwarding a message from a sending terminal to a recipient terminal is explained.

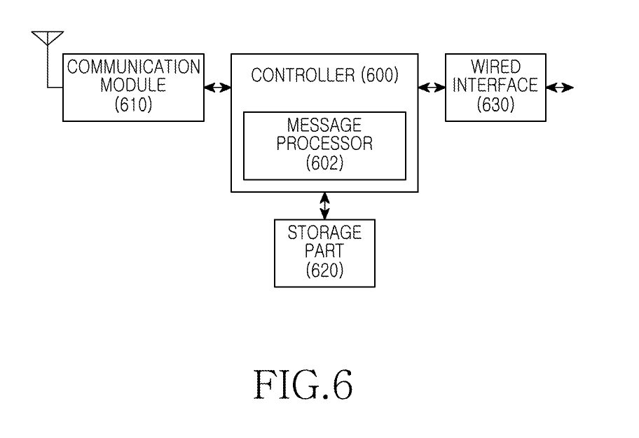

FIG. 6 is a block diagram of a message server in a wireless communication system according to an exemplary embodiment of the present invention.

Referring now to FIG. 6, the message server includes a controller 600, a communication module 610, a storage part 620, and a wired interface 630.

The controller 600 controls operations of the message server. The controller 600 may include a message processor 602. The controller 600 transmits the message with the recipient terminal information determined by the message processor 602.

The message processor 602 extracts the recipient terminal information from the message received from the sending terminal. For example, the message processor 602 may determine based on the user data header of the message whether the user data includes information of the plurality of the recipient terminals. When the user data includes the information of the recipient terminals, the message processor 602 determines the identification information of the recipient terminals of the message, based on the user data of the message.

The communication module 610 processes RF signals transmitted and received over an antenna. For example, the communication module 610 receives the message from the sending terminal. The communication module 610 transmits the message, to at least one recipient terminal, under control of the controller 600.

The storage part 620 can include a program storage area for storing a program to control operations of the message server, and a data storage area for storing data generated in program execution.

The wired interface 630 transmits and receives signals to and from a base station or another message server over a wired network.

As set forth above, when transmitting the message to the plurality of the recipient terminals, the portable terminal of the wireless communication system transmits the list of the recipient terminals together with the message. Thus, overhead in the message transmission can be mitigated.

Further, the portable terminal transmits the response of the message to the multiple terminals using the recipient terminal list of the message. Therefore, the response can be transmitted to the plurality of the recipient terminals without requiring the user's further manipulation.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transmitting a message in a portable terminal, the method comprising:
determining message contents to send to at least one recipient terminal;
determining a number of recipient terminals;
when transmitting the message to at least two recipient terminals, determining identification information of at least two recipient terminals to which the message is transmitted; and
transmitting a message comprising the identification information of the at least two recipient terminals and the message contents to the at least two recipient terminals.

2. The method of claim 1, wherein the transmitting of the message comprises:
generating the message comprising the identification information of the at least two recipient terminals and the message contents; and
transmitting the message to a message server.

3. The method of claim 1,
wherein the message comprises user data and a user data header,
wherein the user data comprises identification information of the at least two recipient terminals and the message contents, and
the user data header indicates whether the user data comprises the identification information of the at least two recipient terminals.

4. A method for transmitting a message in a message server, the method comprising:
when receiving a message from a sending terminal, determining a number of recipient terminals to which the message is transmitted;
if it is determined that the message is transmitted to at least two recipient terminals, determining identification information of each recipient terminal to which the message is transmitted; and
transmitting the message to the recipient terminals respectively.

5. The method of claim 4,
wherein the message comprises user data and a user data header,
wherein the user data comprises identification information of at least one recipient terminal to which the message is transmitted and the message contents, and
wherein the user data header indicates whether the user data comprises the identification information of at least two recipient terminals.

6. The method of claim 5,
wherein the determining of the number of the recipient terminals comprises:
determining whether the message is transmitted to a plurality of recipient terminals according to the user data header of the message received from the sending terminal.

7. The method of claim 4, wherein the transmitting of the message comprises:
transmitting the message generated comprising the identification information of the at least two recipient terminals to which the message is transmitted and message contents, to the recipient terminals respectively using the identification information of the recipient terminals.

8. A method for transmitting a message in a portable terminal, the method comprising:
when receiving a message from a message server, determining whether to send a response to the message;
when sending the response to the message, determining identification information in the message of at least one recipient terminal receiving the message from a sending terminal of the message at the same time; and
sending the response to the message, the response comprising identification information of the sending terminal, the identification information of the at least one recipient terminal, and response contents.

9. The method of claim 8, wherein the determining of the identification information of the recipient terminal comprises:
determining identification information of at least one recipient terminal receiving the message from the sending terminal at the same time, in user data of the received message.

10. The method of claim 8, wherein the sending of the response to the message comprises:
sending the response to the message, the response comprising a user data header and user data, to the message server,
wherein the user data comprises identification information of the sending terminal, the identification information of the at least one recipient terminal, and the response contents, and
the user data header indicates whether the user data comprises identification information of at least two recipient terminals.

11. An apparatus for transmitting a message in a portable terminal, the apparatus comprising:
a controller for, when a message is transmitted to at least two recipient terminals, generating a message comprising identification information of at least two recipient terminals to which the message is transmitted and message contents; and
a communication module for transmitting the message.

12. The apparatus of claim 11, wherein the communication module transmits the message generated by the controller to a message server.

13. The apparatus of claim 11, wherein the controller generates the message comprising user data comprising the identification information of the at least two recipient terminals and the message contents, and a user data header indicating whether the user data comprises the identification information of the at least two recipient terminals.

14. An apparatus for transmitting a message in a message server, the apparatus comprising:
a communication module for transmitting and receiving messages; and
a controller for, when receiving a message from a sending terminal through the communication module, determining a number of recipient terminals to which the message is transmitted, and if it is determined that the message is transmitted to at least two recipient terminals, for controlling to transmit the message to the recipient terminals respectively using identification information of each recipient terminal to which the message is transmitted.

15. The apparatus of claim 14,
wherein the message comprises user data and a user data header,
wherein the user data comprises the identification information of at least one recipient terminal to which the message is transmitted and the message contents, and
wherein the user data header indicates whether the user data comprises the identification information of at least two recipient terminals.

16. The apparatus of claim 15, wherein the controller determines whether the message is transmitted to a plurality of recipient terminals according to the user data header of the message received from the sending terminal.

17. The apparatus of claim 14, wherein the communication module transmits the message generated comprising the identification information of the at least two recipient terminals to which the message is transmitted and message contents, to the recipient terminals respectively using the identification information of the recipient terminals determined by the controller.

18. An apparatus for transmitting a message in a portable terminal, the apparatus comprising:
a communication module for transmitting and receiving messages; and
a controller for, when sending a response to a message received through the communication module, determining identification information in the message of at least one recipient terminal receiving the message from a sending terminal of the message at the same time, and generating a response to the message comprising identification information of the sending terminal, the identification information of the at least one recipient terminal, and response contents.

19. The apparatus of claim 18, wherein the controller determines identification information of at least one recipient terminal receiving the message from the sending terminal at the same time according to user data of the received message.

20. The apparatus of claim 18, wherein the controller generates the response of the message, the response comprising user data comprising identification information of the sending terminal, identification information of the at least one recipient terminal, and the response contents, and a user data header which indicates whether the user data comprises identification information of at least two recipient terminals.
